(19) United States
(12) Patent Application Publication
(10) Pub. No.: US 2003/0016758 A1
(43) Pub. Date: Jan. 23, 2003

(54) Universal interface to external transceiver

(76) Inventors: David Wu, Sunnyvale, CA (US); John Lam, Foothill Ranch, CA (US); Jerry Kuo, San Jose, CA (US); Po-Shen Lai, San Jose, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/899,679

(22) Filed: Jul. 5, 2001

(51) Int. Cl. H04L 23/00; H04L 27/00

(52) U.S. Cl. 375/259; 375/377

(57) ABSTRACT

A universal interface for communicating information to a proprietary physical interface. At least one output module is provided for transmitting information and an input module is provided for receiving the information. The output module and the input module are configured according to communication parameters of a predetermined type of physical interface to which the output module and the input module interface such that communication of the information is facilitated therebetween.

### BACKGROUND OF THE INVENTION

1. Technical Field of the Invention

This invention is related to network switching fabrics and switches, and more specifically, to the transmitter and receivers used for communicating therebetween.

2. Background of the Art

With the advent of the Internet and the potential for enormous revenues which can be realized therefrom, a number of companies have figured prominently in the manufacture and implementation of network switches and other more intricate silicon connectivity solutions utilized for interfacing to high bandwidth networks such as Gigabit Ethernet and Fibre Channel. Consequently, as these companies struggle to be a dominant player in the field, proprietary architectures are introduced which make it problematic for other companies to interface with existing equipment.

What is needed is an interface, which is programmably operable with a variety of proprietary transceiver interfaces.

### SUMMARY OF THE INVENTION

The present invention disclosed and claimed herein, in one aspect thereof, comprises a universal interface for communicating information to a proprietary physical interface. At least one output module is provided for transmitting information and an input module is provided for receiving the information. The output module and the input module are configured according to communication parameters of a predetermined type of physical interface to which the output module and the input module interface such that communication of the information is facilitated therebetween.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a general block diagram of a transmitter and a receiver interfaced to a conventional transceiver pair, according to a disclosed embodiment;

FIG. 2 illustrates a more detailed block diagram of a transmitter and a receiver, according to a disclosed embodiment, interfaced to a conventional 8B/10B transceiver pair;

FIG. 3 illustrates a character and data stream for normal mode operation of the disclosed universal transceiver, according to a disclosed embodiment;

FIG. 4 illustrates a character and data stream for transflush mode operation of the disclosed universal interface, according to a disclosed embodiment; and

FIG. 5 illustrates a block diagram of the contents of a transmit function mapping register.

### DETAILED DESCRIPTION OF THE INVENTION

The disclosed universal data channel interface solves the problem associated with numerous proprietary physical interfaces in the market today by providing a programmable register which is configurable to work with a wide variety of proprietary physical interfaces.

The channel interface comprises a 100 MHz 32-bit data point-to-point link, in addition to three bits of control and one pin for a clocking signal. The thirty-five bits of signal are CMOS, and can be placed on a single board. The disclosed architecture also has application in chassis and stackable system applications where a fast interconnect device is required as the physical transceiver of the communication pipe.

The disclosed universal interface is operable with both Low Voltage Differential Signal (LVDS) and 8B/10B architectures. For example, the LVDS chip fabricated by National Semiconductor transmits all bits in a 35-bit interface without encoding, at a high clock rate. In an application where this type of external transceiver chip is utilized, the data channel interface can be connected directly to the National LVDS chip, since no special encoding or adaptation is necessary.

Another category of physical interface transceiver uses 8B/10B encoding, such as the VSC7214 fabricated by Vitesse Semiconductor Corporation of Camarillo, Calif., and the S2064 quad serial backplane device manufactured by Applied Micro Circuits Corporation (AMCC) of San Diego, Calif. One of the motivations behind the use of 8B/10B encoding lies with the ability to control the characteristics of the code words such as the number of ones and zeros, and the consecutive number of ones and zeros. Another motivation behind 8B/10B encoding is the ability to use special code words, which would be impossible of no coding was performed. Each chip carries four 8-bit channels. Each channel is encoded into a 10-bit signal at a 1 GHz clock rate. The reduced cable, PCB trace count and connector size saves cost and makes PCB design layout easier. Moreover, due to the redundancy of the 8B/10B encoding, there are some unused characters. These special characters are reserved for control purposes. In one implementation, a special character is utilized as a message delimiter, thus replacing the need for extra control bits. The interface can detect invalid characters and provide notification of an erred tick (i.e., a clock cycle having errored data).

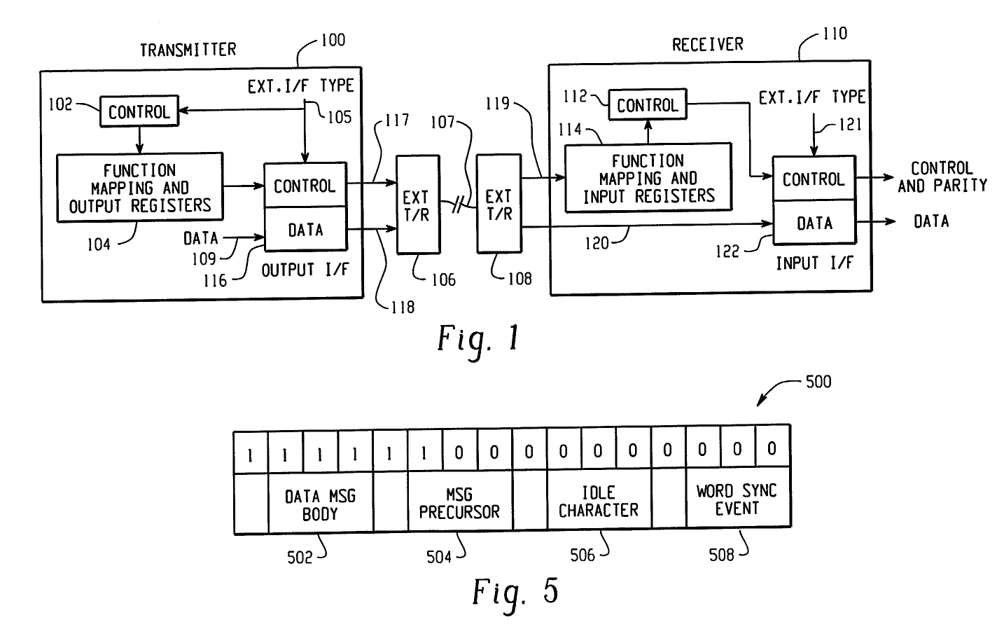

Referring now to FIG. 1, there is illustrated a general block diagram of a transmitter and a receiver, according to a disclosed embodiment, interfaced to a conventional transceiver pair. Note that this discussion encompasses an application where 8B/10B external transceiver devices are employed. Where LVDS devices are utilized, operational differences are noted. A transmitter 100 (or output module) comprises transmit control logic 102 for providing control functions of the output module 100. In an 8B/10B implementation, the transmit control logic 102 controls a register block 104 comprising a transmit function mapping register and an output register for selection, and outputs the contents of the output register to an output interface 116 of the output module 100 in accordance with the type of external transceiver 106 being used. The output interface 116 provides data and control formatting and interface connectivity to the type of manufacturer external transceiver 106. Where an LVDS-type external transceiver 106 (and 108) are used, the register block 104 is not necessary since all data and control bits are encoded prior to the output module 100 and forwarded directly to the external transceiver 106.

The transmit control logic 102 and the output interface 116 both receive an external type input 105 which signals the specific type of external transceiver 106 to which the output module 100 interfaces. The transmit control logic 102 uses this type information to issue one or more control codes to the register block 104 which control how the register contents are to be output to the output interface 116, and ultimately, to the external transceiver 106. Data input to the output interface 116 at a data input 109 is formatted with precursor information by the output interface 116 forming a parallel output data stream with the precursor information (the precursor inputs not shown). The output data stream is formatted in accordance with the type of external transceiver 106, and transmitted thereto over a data path 118. When utilizing LVDS transceiver devices, the output interface 116 also receives parity and control bit information (not shown) directly for insertion into the output interface control bit stream propagated from the output interface 116 to the external transceiver 106 via the control path 117. The transceiver 106 then forwards both the control and data information serialized to a receive-side external transceiver 108 via an interconnect path 107.

On the receive side, a receiver 110 (or input module) comprises similar embodiments of the input module 100 such that a receive control logic 112 operatively connects to a receive register block 114 for interpretation of the data and control information received in communication from the output module 100. The receive register block 114 comprises both a mapping function register and an input register. The receive control logic 112 also connects to input module interface logic 122 of the input module 110 to pass control information thereto related to the particular type of physical interface 108 to which it interfaces. The output of the input module interface logic 122 includes control, data, and parity information. The input module interface logic 122 receives external transceiver type information at an external type input 121 which indicates the specific type of external receive transceiver 108 to which the input module 110 is interfaced. The output of the input module interface logic 122 is converted accordingly in response to this type information for processing by subsequent circuits. The external receive interface 108 separates the control signals from the control and data stream received from the transmit interface 106, and inputs the control signal information via a receive control path 119 into the receive input register of the register block 114. Receive function mapping information (not shown, but discussed in greater detail hereinbelow) is used to ensure that the received control information is inserted into the proper fields of the receive registers 114. The receive transceiver 108 also separates and transmits the 32-bit parallel data and precursor information along a receive data path 120 to the input module interface 122. If an LVDS receive transceiver is utilized, the register block is not required since the data and control signals are decoded at the receive transceiver 108, and can be input directly to the input interface 122.

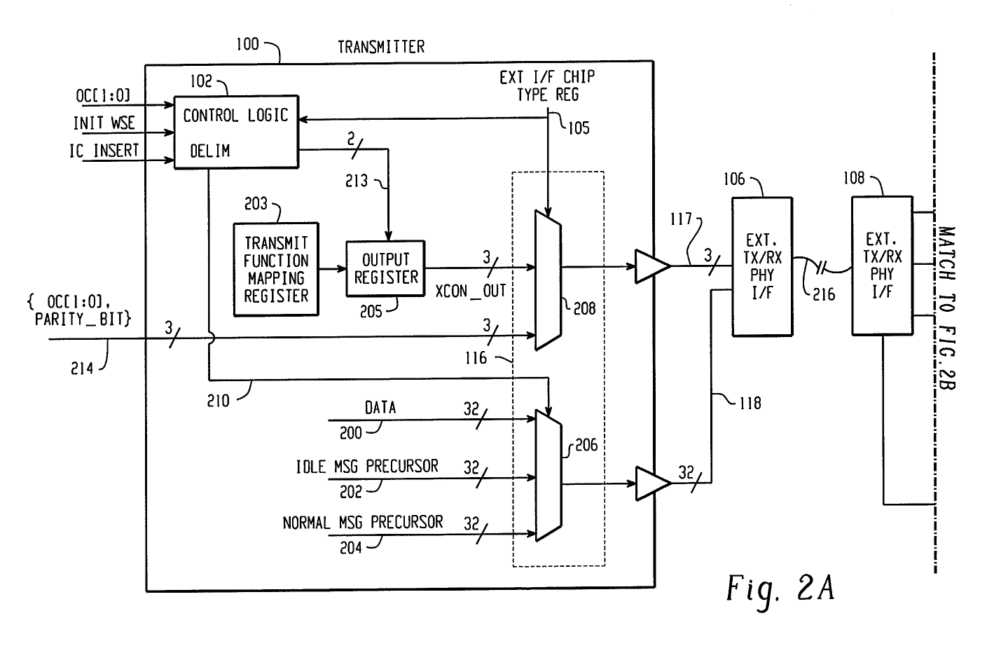

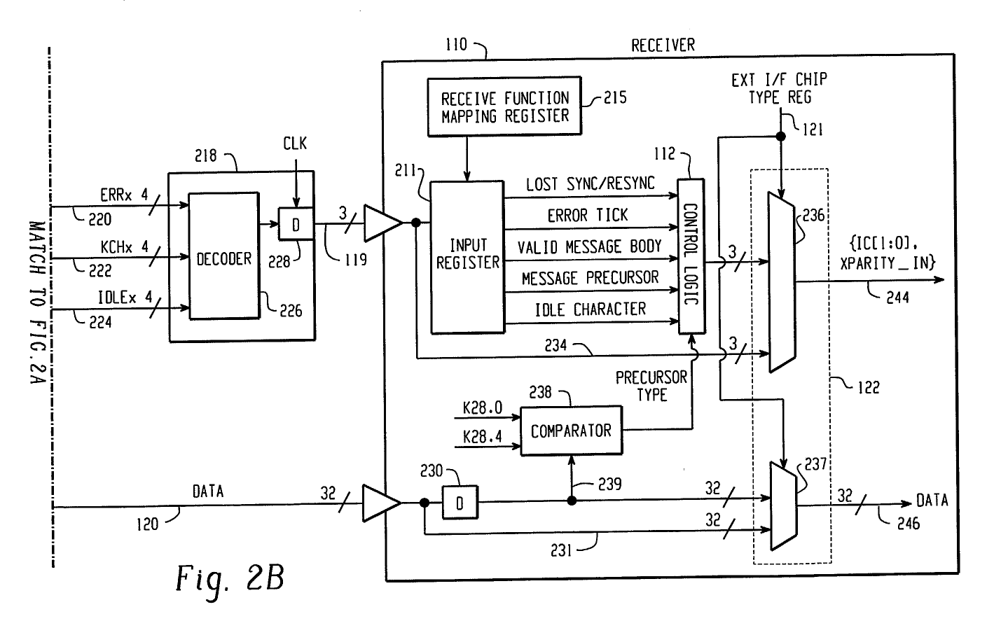

Referring now to FIG. 2, there is illustrated a more detailed block diagram of a transmitter and a receiver, according to a disclosed embodiment, interfaced to a conventional 8B/10B transceiver pair. In this particular implementation, the communication system comprises the output module 100 and the input module 110 interfacing to and communicating via the two proprietary physical transceivers 106 and 108. Each of the transmit interface 106 and the receive interface 108 is a model S2064 chip fabricated by AMCC. The S2064 physical interface contains four transceiver channels for 8B/10B coding and decoding. Thus communication traffic between the two physical interfaces 106 and 108 comprises control and data information of the four channels. The characteristic operating parameters of the proprietary conventional transceivers 106 and 108 are known such that the interface parameters are programmed into the transmit control logic 102 and used for data and control formatting in the output interface 116. The transmit control logic 102 then utilizes these operating parameters to control the function mapping register 104 to facilitate communication with the external transceiver 106.

Parallel data enters the output module 100 at a data input 200 and is formatted in a particular manner for transmission through the interface devices 106 and 108 to the input module 110. A data formatter 206 (as part of the output interface 116) receives 32 -bit data at the data input 200, along with 32-bit idle message precursor information via an idle message precursor input 202 and 32-bit normal message precursor information via a message precursor input 204. The idle message precursor and normal message precursor words are inserted into the output data stream as needed from respective 32-bit parallel connections 202 and 204 via the data formatter 206. The data formatter 206 also communicates with the transmit control logic 102 via a delimiter connection 210 to receive delimiter signals therefrom during the data formatting process. The data and special characters inserted into the data message by the data formatter 206 are output in parallel via the output data connection 118 to the external transceiver 106.

The transmit control logic 102 is operable to control an output register 205 of the register block 104 via a control connection 213 by sending a 2-bit control word to the output register 205. The 2-bit control word indicates which of four 3-bit control words are to be output from a transmit function mapping register 203 of the register block 104 to the output register 205. The control words (xcon_out[2:0]) are ultimately output in 3-bit parallel to a control signal formatter 208, which is part of the output interface 116. The control signal formatter 208 then outputs the control bit information to the external transceiver 106 in 3-bit parallel to control the external transceiver 106 via the output module control connection 117. The control bits permit compatible communication between the output module 100 and the external transceiver 106. Note that implementation of a different transceiver pair may require the use of bit patterns which are compatible with the correspondingly different transmit/receive characteristics. (The function mapping register 203 is discussed in greater detail hereinbelow with respect to FIG. 5.)

The transmit control logic 102 receives as input two bits of delimitation control (OC[1:0]), an initialize WSE (word sync event) signal, and an IC (idle character) insertion signal. The delimitation control bits OC[1:0] provide delimitation to the data formatter 206 such that a normal message precursor special character is inserted between every message body. Additionally, the transmit control logic 102 selects the 3-bit message precursor word for mapping from the mapping register 203 to the output register 205. The WSE initialization signal input to the transmit control logic 102 initiates a word sync event to the control logic 102, which in turn selects the WSE 3-bit register word of the mapping register 203 to be inserted into the output register 205. The WSE signal is then output to the control formatter 208 to commence the synchronization process between the output module and the external transceiver 106. Similarly, the IC insert signal input to the transmit control logic 102 signals the control logic 102 to select the idle character word of the mapping register 203 for insertion into the output register 205.

The control signal formatter 208 receives a parity bit signal and a 2-bit OC[1:0] delimitation control signal as a separate 3-bit word via an input 214. The control signal formatter 208 processes the parity and control information directly when an LVDS-type external transceiver 106 is utilized, since a chip having the LVDS architecture does not require the register mapping function, but can utilize the three bits directly for control.

The 3-bit mapping control signal (xcon_out[2:0]) indicates to the external transmit interface 106 how to interpret the contents of the output register 205 which are soon to follow. As mentioned hereinabove, the control signals also indicate whether the data message is valid (i.e. not corrupted) and also if synchronization is correct between the output module 100 and the transmit interface 106. The transmit control function signals are discussed in greater detail hereinbelow. The transmit control logic 102 and control signal formatter 208 both receive the external transceiver type information of the particular transceivers utilized with the output module 100 via the type connection 105, and uses such type information to communicate the control information from the control signal formatter 206 external physical interface 106.

The control information and data are serialized by the transmit transceiver 106 and transmitted to the external receive transceiver 108 via a connection 216, which connection 216 comprises sufficient capabilities for communication of both control and data information to the receiving external interface 108. The receiver interface 108 deserializes the control and data information of the four aggregated channels of the output module 100 such that each of the four channels has an associated error bit (ERR), a special character bit (KCHx), and an idle character bit (IDLEx). Thus all error information is transmitted to a PAL (Programmable Array Logic) device 218 on four error connections 220 (also denoted ERRx, where x=0, 1, 2, and 3). Similarly, special character information of the four channels is transmitted on four special character connections 222 (also denoted KCHx, where x=0, 1, 2, and 3) to the PAL device 218. Idle character information of the four channels is also passed to the PAL device 218 from the receive interface 108 on four idle character connections 224 (also denoted IDLEx, where x=0, 1, 2, and 3). The PAL device 218 contains a decoder 226 which is utilized to decode the twelve bits of control signal information (ERRx, KCHx, and IDLEx) down to three bits for input to the input module 110. The data information is received in serial from the transmit interface 106 and sent in parallel (xdata_in[31:0]) from the receive interface 108 to the input module 110 via the data channel 120. The PAL device 218 also includes a PAL delay device 228 which has characteristics which match that of an input module delay device 230 for maintaining proper signal delay between the PAL device 218 and the input module 110 when communicating control and data information. Note that if LVDS transceiver devices 106 and 108 are utilized, no delays 228 and 230 are required. Additionally, the PAL device 218 is not required where the LVDS transceiver devices 106 and 108 are implemented.

The control signals (xcon_in[2:0]) of the PAL device 218 are input to an input register 211 of the receive register block 114 of the input module 110 via the control lines 119 for processing by the receive control logic 112. The mapping control signals are transceiver-specific to the external receive interface 108, and are required such that the input module 110 can properly interpret the signals received into the receive register 211. A receive function mapping register 215 of the receive register block 114 connects to the input register 211 such that the receive control logic 114 can properly interpret the received register contents of the input register 211. Table 1 hereinbelow provides the codes for the receive function mapping register. Information received into the control logic 112 from the input register 211 includes information related to lost sync/resync, error tick, valid message body, message precursor, and idle character. If synchronization is lost with the receive transceiver 108 (which has lost sync with the transmit transceiver 106) the input module 110 will wait until sync has recovered to begin receiving data. All data to the input module 110 will be dropped until full sync is restored. The error tick information indicates whether an out-of-band error or a disparity error was detected. The valid message information provides a valid indication when both the data and idle messages are transmitted. The receive control logic 112 processes the input register information and outputs 3-bit control words (xcon_in[2:0]) to the control signal deformatter 236. As mentioned hereinabove with respect to an application utilizing LVDS external transceiver devices, register mapping is not required, and thus a 3-bit word comprising the parity and delimiter signals IC[1:0] is inserted via an LVDS connection 234 directly into the input module control signal deformatter 236 for output therefrom on a 3-bit parallel output line 244. Otherwise, when 8B/10B devices are utilized, the mapping function is required. The input module interface logic 122 comprises both the control signal deformatter 236 and a data deformatter 237 for reconverting the received control and data information, respectively, for downstream use. Both the control deformatter 236 and data deformatter 237 receive type information of the external transceivers from the input module type input 121, which type information is required to properly deformat the received control and data information for downstream use. For example, if an LVDS device is used, the type information controls the control signal deformatter 236 to receive control signal input via the LVDS connection 234. Similarly, the data deformatter is controlled by the type information to utilize the parallel data received via an LVDS data connection 231.

The receive control logic 112 also receives comparator information from a comparator 238. The comparator 238 interrogates the 32-bit parallel data message information from behind the delay 230 via a precursor connection 239 and detects idle message precursor special character information and normal message precursor special character information from the 4-channel data stream which enters the receive module data deformafter 237. The raw data is then output from the data deformatter 237 via an output connection 246 for downstream use. Where LVDS external transceiver devices are utilized, the 32-bit data message bypasses the delay 230 for direct input to the data deformatter 237 via the LVDS data connection 231, and output therefrom at the 32-bit parallel output connection 246.

Referring now to FIG. 3, there is illustrated a character and data stream 300 for normal mode operation of the disclosed universal transceiver, according to a disclosed embodiment. The following in-band control functions are provided and applicable to conventional 8B/10B transceiver chips (e.g., by AMCC). The following are defined as special characters to the transceiver, and cause a special output pattern in the serial bit stream 300. A normal message precursor special character 302 (also denoted as an “NP” eye pattern block) provides message delimitation, and whose function is provided in FIG. 2 by the parity out input (i.e., OC[1:0]). The normal message precursor character 302 is inserted between every data message 304 (2-34 ticks in duration), has a duration of one tick, and a character number of K28.4. (Note that the relationship of the clock pulses to the serialized bit stream are not to be construed as the true timing relationship, but is utilized only for illustration of the various components of the bit stream.) Another special character is an idle message precursor character 306 (also denoted as an “IP” eye block) which has a character number of K28.4, and a one tick duration. Another special character is an idle character 308 (also denoted as the solid black eye block), and which has a character number of K28.5. The output module 100 (and input module 110) uses the idle character 308 to compensate for differences in clock frequency between the modules (100 and 110) and physical interface devices 106 and 108. An idle/flow control character 310 (also denoted as an “I” eye block) carries flow control information and link status information on the 32-bit data. The idle/flow control character 310 is not a special character, is one tick in duration, and is transmitted whenever there is a status change, or when the output transceiver module 100 has no data message 304 to send.

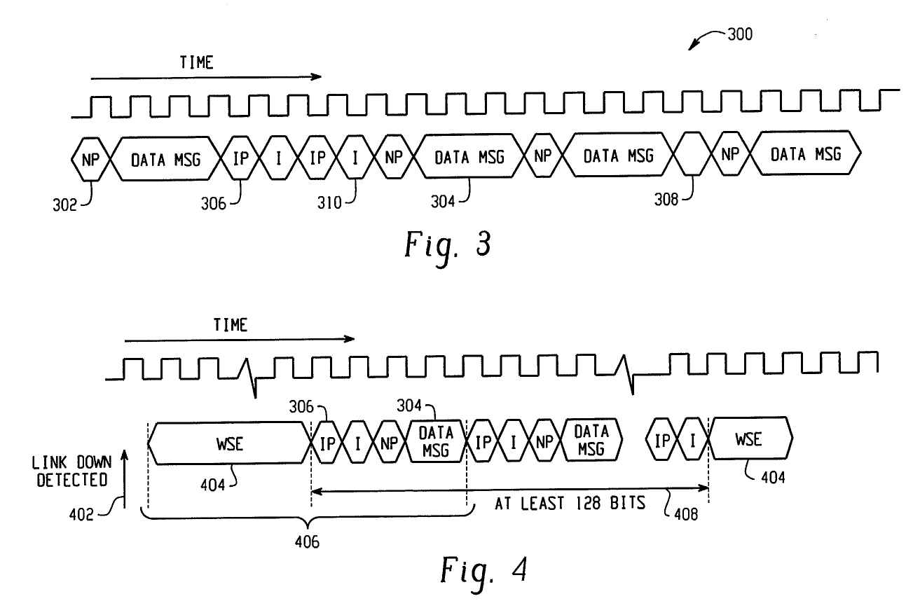

Referring now to FIG. 4, there is illustrated a character and data stream for transflush mode operation of the disclosed universal interface, according to a disclosed embodiment. Upon the occurrence of link-down events such as power-up and/or a hot-swap event, the physical interface 106 needs to be resynchronized to the physical interface 108. The transflush bit configuration 400 performs synchronization (also designated “sync”) between the external transceiver 106 and 108. For example, when a link-down event 402 is detected by the input module 100, input module 100 will initialize a synchronization event, and the transflush serialization occurs. A WSE 404 is utilized for resynchronization (also called re-sync) of the link. The WSE message 404 is a 16 -tick special character sequence used by the output module 100 (or input module 110) for character framing and sync of the four channels of the output module 100. The external transceiver 106 (or 108) does not self-trigger the synchronization procedure. The output module 100 (or the input module 110) triggers on the external transceiver 106 to start the WSE 404. The WSE 404, IDLE message 306, and DATA message 304 form a sync pattern 406 that is transmitted repeatedly until link-up occurs between the external transceivers 106 and 108. In the transflush mode, the duration of the DATA message ranges from two to eighteen ticks. The IDLE message 306 allows the exchange of ICHY (“I Can Hear You”) information, so that the output module 100 and input module 110 can bring up the link. Note that there must be at least 128 ticks between consecutive WSE messages 404, as indicated by the bit spread arrow 408. An invalid-character indication of the input module 110 performs a parity function.

Referring now to FIG. 5, there is illustrated a diagram of the contents of a transfer function mapping register, according to a disclosed embodiment. The different transceiver vendors may have control parameters, so a programmable table is necessary. Each transmit function mapping in the output module 100 is defined in the transmit function mapping register 104 (nineteen bits in length). The register contents 500 include the following control function (xcon_out[2:0]) bits which are transmitted from the transmit function mapping register 203 to the output register 205 through the control signal formatter 208 to control the external transmit transceiver 106: a transmit idle/flow control message; transmit data message body 502; transmit message delimiter 504; transmit idle character 506; and initiate WSE 508.

The following receive control functions (xcon_in[2:0]) are utilized by the receive control logic 112 of the input module 110 to translate the following received control functions: detect xp_out_of_sync; an error tick: “out-of-band error detected”, “disparity error detected”; valid data transmission (both data message and idle message); detect message delimiter; and detect idle character. A translation table included in the receive control logic 112 is used to translate the xcon_in[2:0] bits. The meaning of the xcon_in[2:0] bits is transceiver-specific and also depends upon the decoding logic 226 of the PAL 218. Thus a programmable mapping function is necessary to give meaning to the xcon_in bits. In the following Table 1, a binary A1@ means the particular xcon_in[2:0] bit patterns provide a particular meaning, and a binary A0@ indicates that no meaning is provided.

TABLE 1
Receive Control Functions Translation Table

| | Definition | | | | |
|---|---|---|---|---|---|
| | | | Valid message | | |
| | | | body (data | | |
| Input | Lost | Error | message/idle | Message | Idle |
| xcon_in | sync/resync | Tick | message) | Precursor | Character |
| 000 | 0 | 0 | 1 | 0 | 0 |
| 001 | 0 | 0 | 0 | 1 | 0 |
| 010 | 0 | 0 | 0 | 0 | 1 |
| 011 | 0 | 0 | 0 | 0 | 1 |
| 100 | 0 | 1 | 0 | 0 | 0 |
| 101 | 0 | 1 | 0 | 0 | 0 |
| 110 | 1 | 0 | 0 | 0 | 0 |
| 111 | 1 | 0 | 0 | 0 | 0 |

Although the preferred embodiment has been described in detail, it should be understood that various changes, substitutions and alterations can be made therein without departing from the spirit and scope of the invention as defined by the appended claims.

What is claimed is:

1. A method of communicating information to a physical interface, comprising the steps of:
providing at least an output module for transmitting information and an input module for receiving said information; and
configuring said output module and said input module according to communication parameters of a predetermined type of physical interface to which said output module and said input module interface such that communication of said information is facilitated therebetween.

2. The method of claim 1, wherein said information in the providing step is communicated with a type of said physical interface, which is an 8B/10B device.

3. The method of claim 2, wherein a function mapping register is utilized during the configuring step to provide control words in accordance with said communication parameters of said predetermined type of physical interface.

4. The method of claim 1, wherein said information in the providing step is communicated with a type of said physical interface, which is an LVDS device.

5. The method of claim 4, wherein a mapping function is not required, and said information is encoded and input directly to said physical interface.

6. The method of claim 1, wherein said output module further comprises control logic and one or more registers, said control logic controls said one or more registers in the configuring step in accordance with said communication parameters of said predetermined type of physical interface to which said output module interfaces.

7. The method of claim 1, wherein said input module further comprises control logic and one or more registers, said control logic controls said one or more registers in the configuring step in accordance with said communication parameters of said predetermined type of physical interface to which said input module interfaces.

8. The method of claim 1, wherein said input module and said output module each further comprise control logic and one or more registers, said control logic controls said one or more registers in the configuring step in accordance with said communication parameters of said predetermined type of physical interface to which each said output module and said input module interface.

9. The method of claim 1, wherein said output module further comprises control logic and formatting logic, said control logic controls said formatting logic in the configuring step in accordance with said communication parameters of said predetermined type of physical interface to which said output module interfaces.

10. The method of claim 1, wherein said input module further comprises control logic and deformatting logic, said control logic controls said deformatting logic in the configuring step in accordance with said communication parameters of said predetermined type of physical interface to which said input module interfaces.

11. The method of claim 1, wherein said input module comprises input control logic and formatting logic, and said output module further comprises output control logic and deformatting logic, said input control logic controls said formatting logic in the configuring step in accordance with said communication parameters of said predetermined type of physical interface to which said input module interfaces, and said output control logic controls said deformatting logic in the configuring step in accordance with said communication parameters of said predetermined type of physical interface to which each said input module interfaces.

12. The method of claim 1, further comprising control logic of said output module in the configuring step such that said control logic causes the insertion of special characters into said information when said information is transmitted from said output module.

13. The method of claim 12, wherein said special characters are inserted into said information in the configuring step to compensate for clock frequency variations between said output module and said physical interface.

14. The method of claim 12, wherein said special characters are inserted into said information in the configuring step to delimit said information transmitted from said output module to said physical interface.

15. The method of claim 1, further comprising the step of synchronizing said output and input modules with said physical interface when a loss of synchronization is detected.

16. The method of claim 15, wherein said output module triggers said physical interface to initiate the synchronizing step when said loss of synchronization is detected.

17. The method of claim 15, wherein said loss of synchronization in the synchronizing step is caused by a power-up event.

18. The method of claim 15, wherein said loss of synchronization in the synchronizing step is caused by a hot-swap event.

19. The method of claim 15, wherein when said loss of synchronization is detected, a synchronizing message pattern is transmitted repeatedly from said output module to said corresponding physical interface during the synchronizing step until resynchronization occurs.

20. The method of claim 1, wherein special characters are utilized with said information in the configuring step such that said information is compatibly communicated in accordance with said communication parameters of said type of physical interface to which both said output and input modules interface.

21. The method of claim 1, wherein a mapping function occurs in both said output module and said input module in the configuring step such that said mapping function in said output module occurs between transmit control logic and a transmit register of said output module to communicate said information to said physical interface according transmit communication parameters, and such that said mapping function in said input module occurs between receive control logic and a receive register of said input module to interpret said information received from said physical interface according to communication parameters of said physical interface.

22. An apparatus for communicating information to a physical interface, comprising:
at least an output module for transmitting information and an input module for receiving said information; and
wherein said output module and said input module are each configured according to communication parameters of a predetermined type of the physical interface to which said output module and said input module interface such that communication of said information is facilitated therebetween.

23. The apparatus of claim 22, wherein said information is communicated with a type of said physical interface that is an 8B/10B device.

24. The apparatus of claim 24, wherein a function mapping register is utilized to provide control words in accordance with said communication parameters of said predetermined type of physical interface.

25. The apparatus of claim 22, wherein said information is communicated with a type of said physical interface that is an LVDS device.

26. The apparatus of claim 25, wherein a mapping function is not required, and said information is encoded and input directly to said physical interface.

27. The apparatus of claim 22, wherein said output module further comprises control logic and one or more registers, said control logic controls said one or more registers in accordance with said communication parameters of said predetermined type of physical interface to which said output module interfaces.

28. The apparatus of claim 22, wherein said input module further comprises control logic and one or more registers, said control logic controls said one or more registers in accordance with said communication parameters of said predetermined type of physical interface to which said input module interfaces.

29. The apparatus of claim 22, wherein said input module and said output module each further comprise control logic and one or more registers, said control logic controls said one or more registers in accordance with said communication parameters of said predetermined type of physical interface to which each said output module and said input module interface.

30. The apparatus of claim 22, wherein said output module further comprises control logic and formatting logic, said control logic controls said formatting logic in accordance with said communication parameters of said predetermined type of physical interface to which said output module interfaces.

31. The apparatus of claim 22, wherein said input module further comprises control logic and deformatting logic, said control logic controls said deformatting logic in accordance with said communication parameters of said predetermined type of physical interface to which said input module interfaces.

32. The apparatus of claim 22, wherein said input module comprises input control logic and formatting logic, and said output module further comprises output control logic and deformatting logic, said input control logic controls said formatting logic in accordance with said communication parameters of said predetermined type of physical interface to which said input module interfaces, and said output control logic controls said deformatting logic in accordance with said communication parameters of said predetermined type of physical interface to which each said input module interfaces.

33. The apparatus of claim 22, further comprising control logic of said output module such that said control logic causes the insertion of special characters into said information when said information is transmitted from said output module.

34. The apparatus of claim 33, wherein said special characters are inserted into said information to compensate for clock frequency variations between said output module and said physical interface.

35. The apparatus of claim 33, wherein said special characters are inserted into said information to delimit said information transmitted from said output module to said physical interface.

36. The apparatus of claim 22, wherein said output and input modules are resynchronized with said physical interface after a loss of synchronization is detected.

37. The apparatus of claim 36, wherein said output module triggers said physical interface to initiate when said loss of synchronization is detected.

38. The apparatus of claim 36, wherein said loss of synchronization is caused by a power-up event.

39. The apparatus of claim 36, wherein said loss of synchronization is caused by a hot-swap event.

40. The apparatus of claim 36, wherein when said loss of synchronization is detected, a synchronizing message pattern is transmitted repeatedly from said output module to said corresponding physical interface until resynchronization occurs.

41. The apparatus of claim 22, wherein special characters are utilized with said information such that said information is compatibly communicated in accordance with said communication parameters of said type of physical interface to which both said output and input modules interface.

42. The apparatus of claim 22, wherein a mapping function occurs in both said output module and said input module such that said mapping function in said output module occurs between transmit control logic and a transmit register of said output module to communicate said information to said physical interface according transmit communication parameters, and such that said mapping function in said input module occurs between receive control logic and a receive register of said input module to interpret said information received from said physical interface according to communication parameters of said physical interface.

43. A method of controlling a physical interface device, comprising the steps of:
providing a transmit module and a receive module for the communication of information therebetween;
controlling a register of said transmit module with control logic such that register information of said register is configured in a predetermined manner according to a type of the physical interface device; and
transmitting said information and said register information from said transmit module to the physical interface device in said predetermined manner such that the physical interface communicates said information to said receive module.

44. The method of claim 43, wherein the physical interface device is a 8B/10B device.

45. The method of claim 44, wherein a function mapping register is utilized during the controlling step to provide control words in accordance with said 8B/10B device.

46. The method of claim 45, wherein the physical interface device is an LVDS device.

47. The method of claim 46, wherein a mapping function is not required, and said information is encoded and input directly to said LVDS device.
